(19) United States
(12) Patent Application Publication
(10) Pub. No.: US 2019/0267710 A1
(43) Pub. Date: Aug. 29, 2019

(54) DUAL-BAND MILLIMETER-WAVE ANTENNA SYSTEM

(71) Applicant: QUALCOMM Incorporated, San Diego, CA (US)

(72) Inventors: Jatupum JENWATANAVET, San Diego, CA (US); Mohammad Ali TASSOUDJI, San Diego, CA (US)

(21) Appl. No.: 15/903,301

(22) Filed: Feb. 23, 2018

(51) Int. Cl. H01Q 5/30; H01Q 9/04; H01Q 1/24; H01Q 9/16; H01Q 21/06

(52) U.S. Cl. CPC H01Q 5/30; H01Q 9/0407; H01Q 21/065; H01Q 9/16; H01Q 1/243

(57) ABSTRACT

A dual-band, millimeter-wave antenna system in a mobile device having a top surface, a bottom surface, and an edge surface, includes: a first antenna sub-system configured to radiate first energy in a first millimeter-wave frequency band and directed outwardly from the edge surface, and to radiate second energy in a second millimeter-wave frequency band, separate from the first millimeter-wave frequency band, and directed outwardly from the edge surface; and a second antenna sub-system configured to radiate third energy in the first millimeter-wave frequency band and directed outwardly from the top surface, or the bottom surface, or a combination thereof, and to radiate fourth energy in the second millimeter-wave frequency band and directed outwardly from the top surface, or the bottom surface, or a combination thereof.

### BACKGROUND

Wireless communication devices are increasingly popular and increasingly complex. For example, mobile telecommunication devices have progressed from simple phones, to smart phones with multiple communication capabilities (e.g., multiple cellular communication protocols, Wi-Fi, BLUETOOTH® and other short-range communication protocols), supercomputing processors, cameras, etc. Wireless communication devices have antennas to support cellular communication over a range of frequencies.

It is often desirable to have multiple communication technologies, e.g., to enable multiple communication protocols concurrently, and/or to provide different communication capabilities. For example, mobile communication devices may communicate using different frequencies.

Communicating with different frequencies, however, may be difficult unless the signals can be sufficiently isolated to provide quality communication with all the frequencies.

### SUMMARY

An example of a dual-band, millimeter-wave antenna system in a mobile device having a top surface, a bottom surface, and an edge surface, includes: a first antenna sub-system configured to radiate first energy in a first millimeter-wave frequency band and directed outwardly from the edge surface, and to radiate second energy in a second millimeter-wave frequency band, separate from the first millimeter-wave frequency band, and directed outwardly from the edge surface; and a second antenna sub-system configured to radiate third energy in the first millimeter-wave frequency band and directed outwardly from the top surface, or the bottom surface, or a combination thereof, and to radiate fourth energy in the second millimeter-wave frequency band and directed outwardly from the top surface, or the bottom surface, or a combination thereof.

Implementations of such a system may include one or more of the following features. The first antenna sub-system comprises broadband radiating elements each configured to radiate the first energy in the first millimeter-wave frequency band and the second energy in the second millimeter-wave frequency band. The broadband radiating elements are differential bowtie dipole radiators. The edge surface is a first edge surface, and the first antenna sub-system includes a first array of the differential bowtie dipole radiators disposed to radiate the first energy with a first main beam in a first direction and a second array of the differential bowtie dipole radiators disposed to radiate fifth energy in the first millimeter-wave frequency band with a fifth main beam directed outwardly from a second edge surface of the mobile device and substantially perpendicular to the first main beam.

Also or alternatively, implementations of such a system may include one or more of the following features. The second antenna sub-system includes a first array of patch radiators configured to radiate the third energy in the first millimeter-wave frequency band and a second array of patch radiators configured to radiate the fourth energy in the second millimeter-wave frequency band. The first array of patch radiators is coupled to a first feed network and the second array of patch radiators is coupled to a second feed network that is separate from the first feed network. The first array of patch radiators includes first rectangular patch radiators having first patch edges with each of the first patch edges being either substantially parallel or substantially perpendicular to every other first patch edge, and the second array of patch radiators includes second rectangular patch radiators having second patch edges with each of the second patch edges being either substantially parallel or substantially perpendicular to every other second patch edge and each of the second patch edges being disposed at substantially a 45° angle relative to each of the first patch edges. Each patch radiator in the first array of patch radiators is coupled to a plurality of inputs to produce dual-polarization radiation. Adjacent patch radiators in the first array of patch radiators are coupled to the inputs to be excited with a substantially 180° phase offset with respect to each other. The first array of patch radiators includes a 2×2 array of patch radiators configured to have less than −7.5 dB return loss from 26.5 GHz to 29.5 GHz and the second array of patch radiators includes a 2×2 array of patch radiators configured to have less than −10 dB return loss from 37 GHz to 40 GHz.

An example of a method of sending radio-frequency signals from a wireless mobile communication device includes: radiating first energy in a first millimeter-wave frequency band from the mobile device and directed outwardly from a side of the mobile device; radiating second energy in a second millimeter-wave frequency band from the mobile device and directed outwardly from the side of the mobile device; radiating third energy in the first millimeter-wave frequency band from the mobile device and directed outwardly from a front of the mobile device, or from a back of the mobile device, or a combination thereof; and radiating fourth energy in the second millimeter-wave frequency band from the mobile device and directed outwardly from the front of the mobile device, or from the back of the mobile device, or a combination thereof.

Implementations of such a method may include one or more of the following features. Both the first energy and the second energy are radiated from the same radiating elements. The third energy is radiated with polarization components that are at substantially 45° angles relative to polarization components of the fourth energy. The method further includes feeding adjacent patch radiators, in an array of patch radiators, substantially 180° out of phase relative to each other to radiate energy with the third energy.

An example antenna module includes: a first array of radiators configured to radiate a first millimeter-wave signal in a first direction; a second array of radiators configured to radiate a second millimeter-wave signal in a second direction, the second direction being substantially perpendicular to the first direction, at least a first subset of radiators in the second array of radiators being configured and disposed to radiate the second millimeter wave signal with a first polarization component; and a third array of radiators configured to radiate a third millimeter-wave signal in the second direction or a third direction, the third direction being substantially opposite the second direction, at least a second subset of radiators in the third array of radiators being configured and disposed to radiate the third millimeter wave signal with a second polarization component that is neither parallel to nor perpendicular to the first polarization component.

Implementations of such an antenna module may include one or more of the following features. The antenna module further includes a fourth array of radiators configured to radiate a fourth millimeter-wave signal in a fourth direction, the fourth direction being substantially perpendicular to the first direction and the second direction. The first array of radiators is configured to radiate energy in a first millimeter-wave frequency band, the second array of radiators is configured to radiate energy in the first millimeter-wave frequency band, and the third array of radiators is configured to radiate energy in a second millimeter-wave frequency band separate from the first millimeter-wave frequency band. The first array of radiators is further configured to radiate energy in the second millimeter-wave frequency band. The radiators in the at least a first subset of radiators are configured and disposed, and the radiators in the at least a second subset of radiators are configured and disposed, such that the first polarization component is oriented approximately 45° with respect to the second polarization component.

Also or alternatively, implementations of such an antenna module may include one or more of the following features. The first array of radiators includes an array of dipole radiators, the second array of radiators includes a first array of patch radiators, and the third array of radiators includes a second array of patch radiators. The first array of patch radiators includes a 2×2 array of patch radiators, and the second array of patch radiators includes a 2×2 array of patch radiators interspersed with the patch radiators in the first array of patch radiators. The first array of patch radiators includes a substantially linear array and wherein the second array of patch radiators includes a substantially linear array. The antenna module further includes a first feed network configured to feed adjacent patch radiators in the first array of patch radiators at a substantially 180° phase offset with respect to each other and a second feed network configured to feed adjacent patch radiators in the second array of patch radiators at a substantially 180° phase offset with respect to each other. Each patch radiator in the first array of patch radiators is coupled to first inputs to produce dual-polarization radiation, and each patch radiator in the second array of patch radiators is coupled to second inputs to produce dual-polarization radiation.

Also or alternatively, implementations of such an antenna module may include one or more of the following features. At least each of the radiators in the third array of radiators is configured and disposed to radiate the third-millimeter wave signal with the second polarization component and each of the radiators in the second array of radiators is configured and disposed to radiate the second millimeter-wave signal with the first polarization component.

An example wireless mobile communication device includes: a housing; a screen with a planar top surface; a processor; an intermediate-frequency circuit communicatively coupled to the processor; a front-end circuit communicatively coupled to the intermediate-frequency circuit; and an antenna system communicatively coupled to the front-end circuit and including: a first antenna sub-system configured to radiate energy in a first millimeter-wave frequency band with a first main beam directed substantially parallel to the top surface, and to radiate energy in a second millimeter-wave frequency band with a second main beam directed substantially parallel to the top surface; and a second antenna sub-system configured to radiate energy in the first millimeter-wave frequency band with a third main beam directed substantially perpendicular to the top surface, and to radiate energy in the second millimeter-wave frequency band with a fourth main beam directed substantially perpendicular to the top surface; where the screen, the processor, the intermediate-frequency circuit, the front-end circuit, and the antenna system are retained by the housing.

Implementations of such a device may include one or more of the following features. The housing is substantially rectangular, the antenna system is a first antenna system and is disposed in a first corner of the housing, and the device further includes a second antenna system disposed in a diagonally-opposite corner of the housing relative to the first antenna system. The first antenna system is configured to radiate energy in the first millimeter-wave frequency band with the first main beam and with a fifth main beam directed substantially parallel to the top surface, the first main beam and the fifth main beam being substantially perpendicular to each other, and the second antenna system is configured to radiate energy in the first millimeter-wave frequency band with a sixth main beam and a seventh main beam, the sixth main beam being substantially opposite in direction to the first main beam and the seventh main beam being substantially opposite in direction to the fifth main beam. The second antenna sub-system is configured to radiate the third main beam with polarization components that are at substantially 45° angles relative to polarization components of the fourth main beam. The second antenna sub-system includes: an array of patch radiators configured to radiate the third main beam; and a feed structure coupled to the array of patch radiators to feed adjacent patch radiators substantially 180° out of phase relative to each other.

### BRIEF DESCRIPTION OF THE DRAWINGS

FIG. 1 is a schematic diagram of a communication system.

FIG. 2 is an exploded perspective view of simplified components of a mobile device shown in FIG. 1.

FIG. 3 is a top view of a printed circuit board, shown in FIG. 2, including antenna systems.

FIG. 4 is a top view of patch radiators and dipole radiators of one of the antenna systems shown in FIG. 3.

FIG. 5 is a block flow diagram of a method of sending radio-frequency signals from a wireless mobile communication device.

### DETAILED DESCRIPTION

Techniques are discussed herein for communicating in multiple millimeter-wave frequencies with a wireless communication device. For example, broadband dipole antennas may be provided for communicating across multiple frequency bands for edge-directed communications. The dipole antennas may, for example, be bow-tie dipole antennas. Multiple patch-antenna arrays are provided for perpendicularly-directed communications, with each array configured to operate at a different frequency band of the multiple frequency bands. Patches in one array may be oriented at 45° rotation relative to patches in the other array. Other configurations, however, may be used.

Items and/or techniques described herein may provide one or more of the following capabilities, as well as other capabilities not mentioned. Communication using different millimeter-wave frequency bands of a wireless communication device may be provided with good isolation between signals of the different frequency bands and with good antenna performance. Communication signals of multiple millimeter-wave frequency bands may be transmitted using edge radiators and perpendicular radiators to provide multidirectional, and possibly, omnidirectional communications. Communication bandwidth may be increased relative to single-band communications. Carrier aggregation ability may be enhanced, and as a result, system throughput increased. A dual-band antenna system may be provided with a small form factor. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

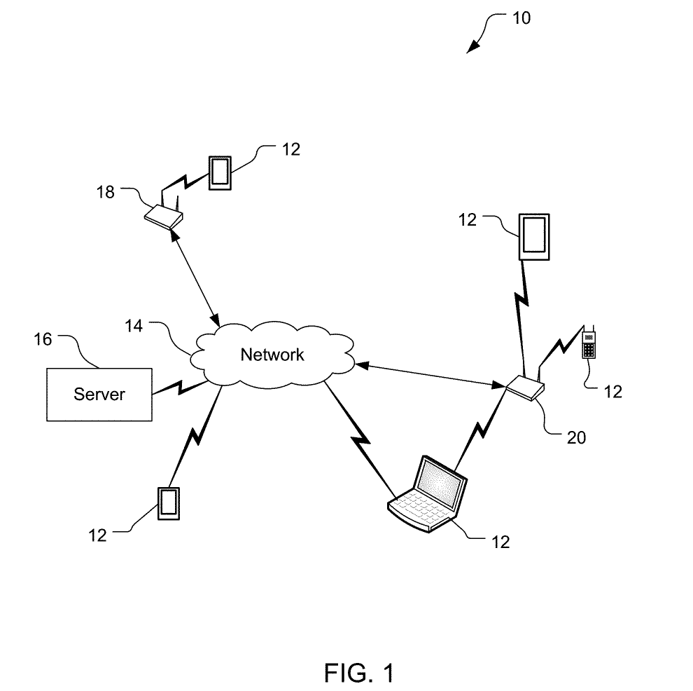

Referring to FIG. 1, a communication system 10 includes mobile devices 12, a network 14, a server 16, and access points (APs) 18, 20. The system 10 is a wireless communication system in that components of the system 10 can communicate with one another (at least some times using wireless connections) directly or indirectly, e.g., via the network 14 and/or one or more of the access points 18, 20 (and/or one or more other devices not shown, such as one or more base transceiver stations). For indirect communications, the communications may be altered during transmission from one entity to another, e.g., to alter header information of data packets, to change format, etc. The mobile devices 12 shown are mobile wireless communication devices (although they may communicate wirelessly and via wired connections) including mobile phones (including smartphones), a laptop computer, and a tablet computer. Still other mobile devices may be used, whether currently existing or developed in the future. Further, other wireless devices (whether mobile or not) may be implemented within the system 10 and may communicate with each other and/or with the mobile devices 12, network 14, server 16, and/or APs 18, 20. For example, such other devices may include internet of thing (IoT) devices, medical devices, home entertainment and/or automation devices, etc. The mobile devices 12 or other devices may be configured to communicate in different networks and/or for different purposes (e.g., 5G, Wi-Fi communication, multiple frequencies of Wi-Fi communication, satellite positioning, one or more types of cellular communications (e.g., GSM (Global System for Mobiles), CDMA (Code Division Multiple Access), LTE (Long-Term Evolution), etc.).

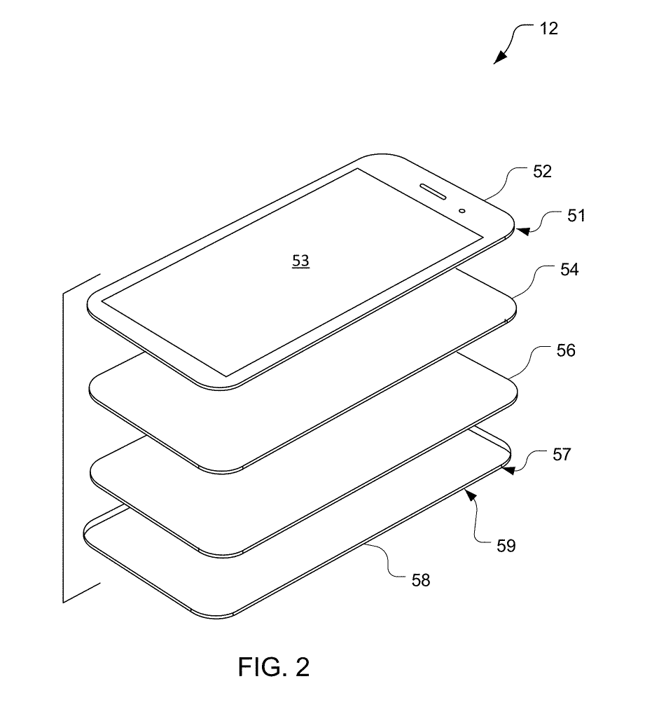

Referring to FIG. 2, an example of one of the mobile devices 12 shown in FIG. 1 includes a top cover 52, a display 54, a printed circuit board (PCB) 56, and a bottom cover 58. The mobile device 12 as shown may be a smartphone or a tablet computer but the discussion is not limited to such devices. The top cover 52 includes a screen 53 that is planar. The screen 53 is planar in that at least part of a top surface 55 of the screen 53 is planar, although the entirety of the screen 53 may not be planar, e.g., may have one or more curved sides. The PCB 56 includes one or more antennas configured to facilitate bi-directional communication between mobile device 12 and one or more other devices, including other wireless communication devices. The bottom cover 58 has a bottom surface 59 and sides 51, 57 of the top cover 52 and the bottom cover 58 provide an edge surface. The top cover 52 and the bottom cover 58 comprise a housing that retains the display 54, the PCB 56, and other components of the mobile device 12 that may or may not be on the PCB 56. For example, the housing may retain (e.g., hold, contain) antenna systems, front-end circuits, an intermediate-frequency circuit, and a processor discussed below. The housing is substantially rectangular, having two sets of parallel edges. In this example, the housing has rounded corners, although the housing may be substantially rectangular with other shapes of corners, e.g., straight-angled (e.g., 45°) corners, 90°, other non-straight corners, etc. Further, the size and/or shape of the PCB 56 may not be commensurate with the size and/or shape of either of the top or bottom covers or otherwise with a perimeter of the device. For example, the PCB 56 may have a cutout to accept a battery. Those of skill in the art will therefore understand that embodiments of the PCB 56 other than those illustrated may be implemented.

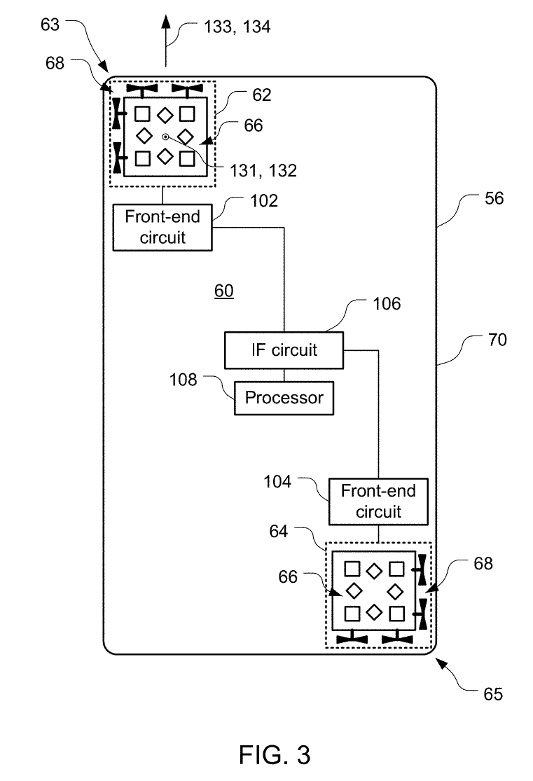

Referring also to FIG. 3, an example of the PCB 56 includes a main portion 60 and two antenna systems 62, 64. In the example shown, the antennas 62, 64 are disposed in diagonally-opposite corners 63, 65 of the PCB 56, and thus, in this example, of the mobile device 12 (e.g., of the housing of the mobile device 12). The main portion 60 includes front-end circuits 102, 104 (also called a radio frequency (RF) circuit), an intermediate-frequency (IF) circuit 106, and a processor 108. The front-end circuits 102, 104 are configured to provide signals to be radiated to the antenna systems 62, 64 and to receive and process signals that are received by, and provided to the front-end circuits 102, 104 from, the antenna systems 62, 64. The front-end circuits 102, 104 are configured to convert received IF signals from the IF circuit 106 to RF signals (amplifying with a power amplifier as appropriate), and provide the RF signals to the antenna systems 62, 64 for radiation. The front-end circuits 102, 104 are configured to convert RF signals received by the antenna systems 62, 64 to IF signals (e.g., using a low-noise amplifier and a mixer) and to send the IF signals to the IF circuit 106. The IF circuit 106 is configured to convert IF signals received from the front-end circuits 102, 104 to baseband signals and to provide the baseband signals to the processor 108. The IF circuit 106 is also configured to convert baseband signals provided by the processor to IF signals, and to provide the IF signals to the front-end circuits 102, 104. The processor 108 is communicatively coupled to the IF circuit 106, which is communicatively coupled to the front-end circuits 102, 104, which are communicatively coupled to the antenna systems 62, 64, respectively.

The antenna systems 62, 64 may be formed as part of the PCB 56 in a variety of manners. For example, the antenna systems 62, 64 may be integral with a board, e.g., a dielectric board or a semiconducting board, of the PCB 56, being formed as integral components of the board. In this case, the dashed lines around the antenna systems indicate functional separation of the antenna systems 62, 64 (and the components thereof) from other portions of the PCB 56. Alternatively, one or more components of the antenna system 62 and/or the antenna system 64 may be formed integrally with the board of the PCB 56, and one or more other components may be formed separate from the board and mounted to the board of (or otherwise made part of) the PCB 56. Alternatively, both of the antenna systems 62, 64 may be formed separately from the board of the PCB 56, mounted to the board and coupled to the front-end circuits 102, 104, respectively. In some examples, one or more components of the antenna system 62 may be integrated with the front-end circuit 102, e.g., in a single module or on a single circuit board. Also or alternatively, one or more components of the antenna system 64 may be integrated with the front-end circuit 104, e.g., in a single module or on a single circuit board.

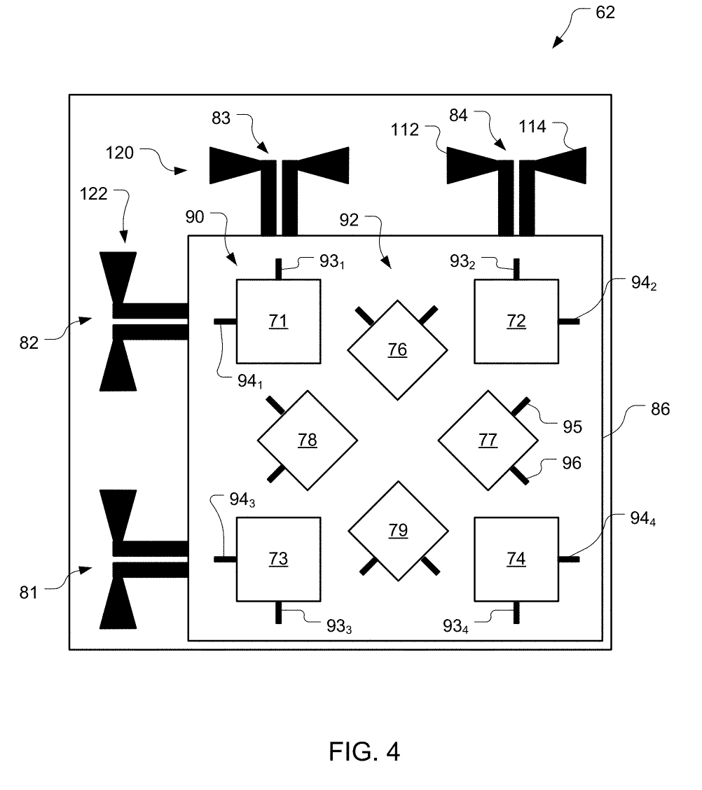

The antenna systems 62, 64 are configured similarly, here as dual-band, millimeter-wave antenna systems with multiple radiators to facilitate communication with other devices at various directions relative to the mobile device 12. The multiple radiators are configured to operate at different frequencies, e.g., different millimeter-wave frequency bands, such that the antenna systems 62, 64 are dual-band, millimeter-wave antenna systems. In the example of FIG. 3, the antenna systems 62, 64 include antenna sub-systems 66, 68, with the antenna sub-system 66 comprising patch radiators and the antenna sub-system 68 comprising dipole radiators, as further shown, for example, in FIG. 4. In other examples, one or more antenna systems may include one or more dipole radiators only, two or more patch radiators only that are configured to radiate at different frequency bands, or a combination of one or more dipole radiators and two or more patch radiators. In other examples, one or more other types of radiators may be used alone or in combination with one or more dipole radiators and/or one or more patch radiators.

In the example shown in FIG. 3, the antenna sub-system 66 may be configured to radiate signals primarily to, and receive signals primarily from, above and/or below a plane of the PCB 56, i.e., into and/or out of the page showing FIG. 3, substantially perpendicular (e.g., 90°±10°) to the planar screen 53. The antenna sub-system 66 may be configured to radiate signals and to receive signals in multiple millimeter-wave frequency bands, radiating the signals directed outwardly from a top surface (out of the page as shown in FIG. 3), a bottom surface, or a combination thereof of the mobile device 12. In the example shown in FIG. 3, main beams 131, 132 represent composite main beams formed from contributions from patches from respective patch arrays (see discussion with respect to FIG. 4) and are directed perpendicularly to the top surface of the mobile device 12, i.e., patches in respective arrays fed in phase with no beam steering. Here, the main beams 131, 132 are indicated by lines coming out of the page of FIG. 3 for simplicity, but the main beams 131, 132 will span non-zero angular widths. Signals radiated outwardly from a surface may not originate from the surface, but propagate outwardly therefrom. The antenna sub-system 66 may include a ground plane such that signals are radiated to and received from one side of the ground plane, e.g., through the top of the device 12 such as through the screen 53. Alternatively, the antenna sub-system 66 may be disposed to radiate to and receive signals through a bottom surface of the mobile device 12, e.g., of the bottom cover 58. Alternatively still, the antenna sub-system 66 may be duplicated on the other side of the ground plane to radiate signals to and receive signals from both sides of the ground plane, e.g., through a combination of the top surface and the bottom surface of the mobile device 12. The antenna systems 62, 64 are positioned in or near the corners 63, 65 of the PCB 56 to help provide spatial diversity (directions relative to the mobile device 12 to which signals may be transmitted and from which signals may be received), e.g., to help increase MIMO (Multiple Input, Multiple Output) capability. Further, the antenna sub-system 66 may be configured to provide dual polarization radiation and reception. The main beams 131, 132 of the antenna sub-system 66 may be directed substantially perpendicular (e.g., within ±10° of perpendicular) to the plane of the screen 53. The main beams 131, 132 are main beams at the different frequencies radiated by the antenna sub-system 66, and may share a direction.

Also in the example of FIG. 3, the antenna sub-system 68 may be configured to radiate energy in multiple millimeter-wave frequency bands with main beams 133, 134 directed outwardly from an edge surface of the mobile device 12. The antenna sub-system 68 may include one or more broadband radiating elements (e.g., differential bowtie dipole radiators as shown) each configured to radiate energy in multiple different, separate millimeter-wave frequency bands. The antenna sub-system 68 is configured to radiate signals primarily to, and receive signals primarily from, sides of PCB 56 through an edge surface of the mobile device 12, with the antenna sub-system 68 in the antenna system 62 configured to radiate primarily to the top and left of the PCB 56 as shown in FIG. 3 and the antenna sub-system 68 in the antenna system 64 configured to radiate primarily to the right and bottom of the PCB 56, through an edge surface of the mobile device 12, as shown in FIG. 3. The edge surface may comprise the combined sides 51, 57 of the top cover 52 and the bottom cover 58. Thus, the antenna sub-system 68 may be considered to be an edge-fired antenna sub-system. The main beams 133, 134 of the antenna sub-system 68 may be directed substantially parallel (e.g., within ±10° of parallel) to the plane of the screen 53. The main beams 133, 134 are main beams at the different frequencies radiated by the antenna sub-system 68, and may (as shown) share a direction. Further, multiple main beams of the sub-system 68 of the antenna system 62 may be directed substantially perpendicular (e.g., 90°±10°) to each other (e.g., to the left and upward in FIG. 3), and multiple main beams of the sub-system 68 of the antenna system 64 may be directed substantially perpendicular (e.g., 90°±10°) to each other and substantially opposite (e.g., 180°±10°) in direction (e.g., to the right and down in FIG. 3) to the main beams of the sub-system 68 of the antenna system 62.

In some embodiments, the antenna systems 62, 64 may be disposed over areas about 15 mm×15 mm of the PCB 56. This may provide sufficient electrical characteristics for communication without occupying a large area within the device 12.

The PCB 56 may comprise a multi-layer substrate 70 and may include the antenna systems 62, 64 integrally formed therein. For example, the antenna systems 62, 64 may comprise eight layers, 14 layers, or another quantity of layers. Alternatively, the antenna systems 62, 64 may comprise a multi-layer (e.g., 14-layer) FCBGA (Flip Chip Ball Grid Array) and may be mounted on a board of the PCB 56.

Referring also to FIG. 4, the antenna system 62 includes patch radiators 71, 72, 73, 74, patch radiators 76, 77, 78, 79, dipole radiators 81, 82, 83, 84, and a ground plane 86. The patch radiators 71-74 and the dipole radiators 81-84 may comprise flat metal pieces each disposed in a layer of the antenna system 62. The patch radiators 71-74 and the patch radiators 76-79 may all be disposed in the same layer of the antenna system 62, or may be disposed in different layers, e.g., with the patch radiators 71-74 disposed in one layer and the patch radiators 76-79 disposed in another layer. The dipole radiators 81-84 may all be disposed in the same layer, and may or may not be disposed in the same layer as the patch radiators 71-74 and/or the patch radiators 76-79. For example, the patch radiators 71-74, 76-79 may be disposed in the 8^{th} layer of a 14-layer substrate and the dipole radiators 81-84 may be disposed in the 5^{th} layer of the 14-layer substrate, although other layer locations of the radiators 71-74, 76-79, 81-84 may be used. The ground plane 86 underlies the patch radiators 71-74, 76-79 and spans an area, e.g., 13 mm×13 mm if the antenna system 62 spans 15 mm×15 mm. In FIG. 4, the patch radiators 71-74, 76-79, the dipole radiators 81-84, and the ground plane 86 are all shown in solid lines, but are disposed in different layers of the PCB 56. Broken lines in FIG. 3 represent regions of the antenna systems 62, 64 extending through all the layers of the substrate 70. The dipole radiators 81-84 are broadband radiators configured to radiate signals across multiple frequency bands while the patch radiators 71-74 and the patch radiators 76-79 are single-band radiators configured to radiate signals in respective single frequency bands. The patch radiators 71-74 comprise an array 90 and the patch radiators 76-79 comprise an array 92, with each of the arrays 90, 92 configured to radiate and receive energy at a respective frequency band for wireless communication.

The array 90 is configured to radiate and receive energy at a first frequency band. For example, the array 90 is a 2×2 array of the patch radiators 71-74, with each of the patch radiators 71-74 being configured to radiate energy at the first frequency band, e.g., a lower millimeter-wave frequency band such as a band including 28 GHz, e.g., a frequency band from 26.5 GHz to 29.5 GHz. For example, the array 90 may be configured to have less than −7.5 dB return loss from 26.5 GHz to 29.5 GHz. Here, each of the patch radiators 71-74 is a rectangle, in this example a square, with each side having a length that determines a wavelength at which each of the patches 71-74 will radiate energy, with the length measuring substantially half of a lower-band radiating wavelength, e.g., between 40% of the lower-band radiating wavelength and half of the lower-band radiating wavelength. The lower-band radiating wavelength is the wavelength in the array 90, e.g., in a dielectric of the substrate 70, corresponding to a patch radiating frequency (here a lower-band radiating frequency) at which the patches 71-74 radiate energy. Alternatively, the patch radiators 71-74 may be rectangles with different lengths of sides and thus have two different patch radiating frequencies. In this example, the array 90 is arranged such that each of the center-to-center distances between the patch radiator 71 and the patch radiator 72 and the center-to-center distance between the patch radiator 73 and the patch radiator 74 is about 6.2 mm. Further, in this example, the array 90 is arranged such that each of the center-to-center distances between the patch radiator 71 and the patch radiator 73 and the center-to-center distance between the patch radiator 72 and the patch radiator 74 is about 6.2 mm.

The array 92 is configured to radiate and receive energy at a second frequency band, with the second frequency band being different from the first frequency band. For example, the array 92 is a 2×2 array of the patch radiators 76-79, with each of the patch radiators 76-79 being configured to radiate energy at the second frequency band, e.g., a higher millimeter-wave frequency band such as a band including 38 GHz, e.g., a frequency band from 37 GHz to 40 GHz. For example, the array 92 may be configured to have less than −10 dB return loss from 37 GHz to 40 GHz. Here, each of the patch radiators 76-79 is a rectangle, in this example a square, with each side having a length that determines a wavelength at which each of the patches 76-79 will radiate energy, with the length measuring substantially half of a higher-band radiating wavelength, e.g., between 40% of the higher-band radiating wavelength and half of the higher-band radiating wavelength. The higher-band radiating wavelength is the wavelength in the array 92, e.g., in a dielectric of the substrate 70, corresponding to a patch radiating frequency (here a higher-band radiating frequency) at which the patches 76-79 radiate energy. Alternatively, the patch radiators 76-79 may be rectangles with different lengths of sides and thus have two different patch radiating frequencies. In this example, the array 92 is arranged such that each of the center-to-center distances between the patch radiator 76 and the patch radiator 77 and the center-to-center distance between the patch radiator 78 and the patch radiator 79 is about 3.8 mm. Further, in this example, the array 92 is arranged such that each of the center-to-center distances between the patch radiator 76 and the patch radiator 78 and the center-to-center distance between the patch radiator 77 and the patch radiator 79 is about 3.8 mm.

The array 92 is oriented with a substantially 45° rotation (e.g., 45°±10°) relative to the array 90 and vice versa. Each of the patch radiators 76-79 is oriented with a 45° rotation relative to the patch radiators 71-74, i.e., edges of the patch radiators 76-79 are at substantially 45° angles relative to edges of the patch radiators 71-74 and vice versa. The relative orientations of the arrays 90, 92 and the fact that the patch radiators 71-74, 76-79 radiate polarized signals means that the polarization components (e.g., due to each of the ports 93-96) of the signals radiated by the arrays 90, 92 will be oriented at substantially 45° (e.g., 45°±10°) relative to each other and thus patch radiators 71-74 are less likely to cross-couple with the patch radiators 76-79, and vice versa, than if the arrays 90, 92 were oriented such that their polarized signals were aligned with each other instead of being askew relative to each other. With this configuration, patch edges of the patch radiators 71-74 are either substantially parallel (e.g., parallel ±10°) or substantially perpendicular (e.g., perpendicular ±10°) to every other patch edge of the patch radiators 71-74. Further patch edges of the patch radiators 76-79 are either substantially parallel (e.g., parallel ±10°) or substantially perpendicular (e.g., perpendicular ±10°) to every other patch edge of the patch radiators 76-79, and disposed at substantially a 45° angle (e.g., 45°±10°) relative to each of the edges of the patch radiators 71-74. In other embodiments, the patch radiators 71-74 of the array 90 may be rotated an amount other than 45° with respect to the patch radiators 76-79 of the array 92.

The array 90 is coupled to the processor 108 through one feed network and the array 92 is coupled to the processor 108 through a separate feed network. The feed networks may comprise separate paths in the IF circuit 106 and the front-end circuits 102, 104, separate connections between the processor 108 and the IF circuit 106, between the IF circuit 106 and the front-end circuits 102, 104, and between the front-end circuits 102, 104 and the antenna systems 62, 64, and separate feed lines (i.e., feed structures) in the antenna systems 62, 64 to the ports 93, 94 and to the ports 95, 96. In some embodiments, a subset of the separate paths and/or connections exist for each of the separate feed networks. For example, in some embodiments, separate paths and/or connections may be maintained from the antenna systems 62, 64 to the IF circuit 106, but may be combined at or nearer to the processor 108. The separate feed networks may facilitate carrier aggregation of signals received by the antenna systems 62, 64, e.g., by avoiding the use of a diplexer in each of the front-end circuits 102, 104.

Each of the patch radiators 71-74 is connected to two ports 93, 94 and each of the patch radiators 76-79 is connected to two ports 95, 96 to receive signals to be radiated and to convey received signals. The ports 93-96 are connected to respective sides of the patch radiators 71-74, 76-79 to produce dual-polarization radiation and to receive signals of corresponding polarizations. The ports 93-96 of the arrays 90, 92 are connected to the RF circuit 102 such that two different feeds from the RF circuit 102 are connected to the arrays 90, 92, with one feed connected to the array 90 and a different feed connected to the array 92. Further, the RF circuit 102 and/or circuitry between the RF circuit 102 and the antenna systems 62, 64 is configured to provide signals to be radiated to the ports 93-96 such that adjacent patch radiators in each of the arrays 90, 92 are driven with signals that are substantially 180° (e.g., 180°±10°) out of phase. For example, for the array 90, outbound signals at the ports 93₁, 93₂ have substantially the same phase while outbound signals at the ports 94₁, 94₂ are substantially 180° out of phase with respect to each other. Similarly, outbound signals at the ports 93₃, 93₄ have substantially the same phase while outbound signals at the ports 94₃, 94₄ are substantially 180° out of phase with respect to each other. Further, outbound signals at the ports 93₁, 93₃ are substantially 180° out of phase with respect to each other and outbound signals at the ports 93₂, 93₄ are substantially 180° out of phase with respect to each other. Further still, outbound signals at the ports 94₁, 94₃ have substantially the same phase and outbound signals at the ports 94₂, 94₄ have substantially the same phase. The array 92 is similarly driven, with the ports 95, 96 corresponding to the ports 93, 94 having respective outbound signals with substantially the same phase or being substantially 180° out of phase with respect to each other as discussed with respect to the array 90.

Each of the arrays 90, 92 is illustrated in FIGS. 3-4 as being a 2×2 array. In other embodiments, either or both of the arrays 90, 92 may have a greater or less number of patch radiators, or may be arranged in a different configuration. For example, one or both of the arrays 90, 92 may be disposed as a linear array. In some embodiments of linear arrays, the patch radiators of the array 90 are disposed along an edge of the ground plane 86 nearest the dipole radiators 83, 84, and the patch radiators of the array 92 are disposed along an edge of the ground plane 86 nearest the dipole radiators 81, 82. In other embodiments, the array 90 comprises a linear array arranged parallel to the array 92, which is also a linear array. In yet other embodiments, the patch radiators of the array 90 are arranged linearly and are interspersed with (e.g., alternating with) the patch radiators of the array 92. In such embodiments, the dipole radiators of the antenna sub-system 68 may be arranged along one edge of the ground plane 86.

Each of the dipole radiators 81-84 is configured to radiate signals over both the lower millimeter-wave frequency band and the higher millimeter-wave frequency band. Here, the dipole radiators 81-84 are common-fed, differential bowtie dipole radiators. Each of the dipole radiators 81-84 is common fed in that signals from the lower millimeter-wave frequency band and signals from the higher millimeter-wave frequency band are sent to each of the dipole radiators 81-84 on a single transmission line and may be sent concurrently. Alternatively, signals from the different frequency bands may be sent to the dipole radiators 81-84 using separate transmission lines. Each of the dipole radiators 81-84 is a differential dipole radiator in that signals provided to a left-hand side 112 of the respective radiator are substantially 180° (e.g., 180°±10°) out of phase with respect to signals provided to a right-hand side 114 of the respective radiator. The dipole radiators 81-84 are disposed in two 1×2 arrays 120, 122 along respective sides of the ground plane 86 corresponding to edges of the PCB 56. The arrays 120, 122 are configured to radiate energy in multiple frequency bands with respective main beams, and with the main beam of each of the frequency bands from the array 120 being substantially perpendicular (e.g., 90°±10°) from the respective main beam from the array 122. In some embodiments, each of the arrays 120, 122 have a greater number of dipole radiators than illustrated in FIGS. 3 and 4.

The patch radiators 71-74, 76-79 and the dipole radiators 81-84 are configured to radiate energy efficiently and with good directionality. For example, experimental results yielded return loss for the patch radiators 71-74 of less than −7.5 dB over 26.5 GHz-29.5 GHz and return loss for the patch radiators 76-79 of less than −10.0 dB over 37 GHz-40 GHz. Further, experimental results yielded array gain for the patch radiators 71-74 of at least 10.5 dB over 26.5 GHz-29.5 GHz and array gain for the patch radiators 76-79 of at least 9.2 dB over 37 GHz-40 GHz. Further, experimental results yielded return loss for the dipole radiators 81-84 of less than −9.5 dB over 26.5 GHz-40 GHz.

The patch radiators 71-74 may have a feed network that is separate from a feed network for the patch radiators 76-79. Thus, the patch radiators 71-74 may be part of an RF chain that is separate from an RF chain including the patch radiators 76-79. Having separate feed chains may facilitate carrier aggregation of signals received by the patch radiators 71-74 and the patch radiators 76-79. For example, by using separate feed chains, a diplexer may not be needed that would be required if a single, dual-band radiator arrangement was used.

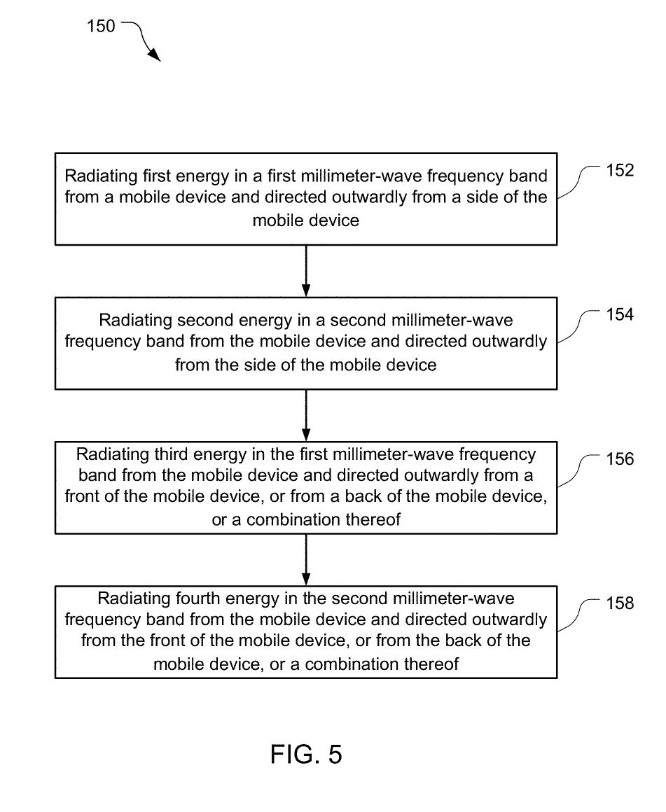

Referring to FIG. 5, with further reference to FIGS. 1-4, a method 150 of sending radio-frequency signals from a wireless mobile communication device includes the stages shown. The method 150 is, however, an example only and not limiting. The method 150 may be altered, e.g., by having stages added, removed, rearranged, combined, performed concurrently, and/or having single stages split into multiple stages.

At stage 152, the method 150 includes radiating first energy in a first millimeter-wave frequency band from a mobile device and directed outwardly from a side of the mobile device. For example, the dipole radiators 83-84 of the antenna sub-system 68 may radiate energy in the 28 GHz band, e.g., the main beam 133, directed through a side of the mobile device 12, e.g., substantially parallel to a plane of the PCB 56 and substantially parallel to a plane of the screen 53, e.g., a top surface of the mobile device 12.

At stage 154, the method 150 includes radiating second energy in a second millimeter-wave frequency band from the mobile device and directed outwardly from the side of the mobile device. For example, the dipole radiators 83-84 of the antenna sub-system 68 may radiate energy in the 38 GHz band, e.g., the main beam 134, directed through a side of the mobile device 12, e.g., substantially parallel to a plane of the PCB 56 and substantially parallel to a plane of the screen 53, e.g., a top surface of the mobile device 12. Thus, in this example, the same radiating elements, here the dipole radiators 83-84, radiate both the first energy and the second energy, for example, the main beams 133, 134.

At stage 156, the method 150 includes radiating third energy in the first millimeter-wave frequency band from the mobile device and directed outwardly from a front and/or a back of the mobile device. For example, the array 90 of the patch radiators 71-74 of the antenna sub-system 66 may radiate energy in the 28 GHz band, e.g., the main beam 131, directed through a top surface of the mobile device 12, e.g., substantially perpendicular to a plane of the PCB 56 and substantially perpendicular to a plane of the screen 53.

At stage 158, the method 150 includes radiating fourth energy in the second millimeter-wave frequency band from the mobile device and directed outwardly from the front and/or the back of the mobile device. For example, the array 92 of the patch radiators 76-79 of the antenna sub-system 66 may radiate energy in the 38 GHz band, e.g., the main beam 132, directed through a top surface of the mobile device 12, e.g., substantially perpendicular to a plane of the PCB 56 and substantially perpendicular to a plane of the screen 53. Stages 156 and 158 may include radiating the third energy, e.g., the main beam 131, with polarization components that are at substantially 45° angles relative to polarization components of the fourth energy, e.g., the main beam 132. Also or alternatively, stage 156 and/or stage 158 may include feeding adjacent patch radiators, in the array 90 and/or the array 92, substantially 180° out of phase relative to each other, e.g., as discussed above with respect to FIG. 4. In some embodiments, energy is radiated in one or more (or all) of stages 152-158 with dual polarization.

The discussion above of examples of the method 150 focused on the dipole radiators 83-84 of the antenna sub-system 68. The discussion applies equally to the dipole radiators 81-82, and applies to both the antenna systems 62, 64, as well as other antenna systems that may be used (e.g., along a side of the mobile device 12 and not a corner, e.g., with only one set of dipole radiators used). Still other configurations may be used, and other methods of use implemented.

Other Considerations

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

1. A dual-band, millimeter-wave antenna system in a mobile device having a top surface, a bottom surface, and an edge surface extending between the top surface and the bottom surface, the antenna system comprising:
a first antenna sub-system comprising at least one first flat metal portion configured to radiate first energy in a first millimeter-wave frequency band and directed outwardly from the edge surface, and comprising at least one second flat metal portion configured to radiate second energy in a second millimeter-wave frequency band, separate from the first millimeter-wave frequency band, and directed outwardly from the edge surface, the first antenna sub-system configured to radiate the first and second energy at respective first and second boresights directed substantially parallel to the at least one first flat metal portion and the at least one second flat metal portion; and
a second antenna sub-system comprising at least one third flat metal portion substantially parallel to the at least one first flat metal portion and the at least one second flat metal portion and configured to radiate third energy in the first millimeter-wave frequency band and directed outwardly from the top surface, or the bottom surface, or a combination thereof, and the second antenna sub-system comprising at least one fourth flat metal portion substantially parallel to the at least one third flat metal portion and configured to radiate fourth energy in the second millimeter-wave frequency band and directed outwardly from the top surface, or the bottom surface, or a combination thereof, the second antenna sub-system configured to radiate the third and fourth energy at respective third and fourth boresights directed substantially perpendicular to the at least one third flat metal portion and the at least one fourth flat metal portion, respectively, the second antenna sub-system being disposed adjacent to the first antenna sub-system.

2. The antenna system of claim 1, wherein each of the at least one first flat metal portion and the at least one second flat metal portion is configured to radiate the first energy in the first millimeter-wave frequency band and the second energy in the second millimeter-wave frequency band.

3. The antenna system of claim 2, wherein each of the at least one first flat metal portion and the at least one second flat metal portion is a differential bowtie dipole radiator.

4. The antenna system of claim 3, wherein the edge surface is a first edge surface, and wherein the first antenna sub-system comprises a first array of the differential bowtie dipole radiators disposed to radiate the first energy at the first boresight and a second array of the differential bowtie dipole radiators disposed to radiate fifth energy in the first millimeter-wave frequency band at a fifth boresight directed outwardly from a second edge surface of the mobile device and substantially perpendicular to the first boresight.

5. The antenna system of claim 1, wherein the each of the at least one third flat metal portion comprises a first patch of a first array of patch radiators configured to radiate the third energy in the first millimeter-wave frequency band and each of the at least one fourth flat metal portion comprises a second patch of a second array of patch radiators configured to radiate the fourth energy in the second millimeter-wave frequency band.

6. The antenna system of claim 5, wherein the first array of patch radiators is coupled to a first feed network and the second array of patch radiators is coupled to a second feed network that is separate from the first feed network.

7. The antenna system of claim 5, wherein the first array of patch radiators comprises a plurality of first rectangular patch radiators having first patch edges with each of the first patch edges being either substantially parallel or substantially perpendicular to every other first patch edge, and wherein the second array of patch radiators comprises a plurality of second rectangular patch radiators having second patch edges with each of the second patch edges being either substantially parallel or substantially perpendicular to every other second patch edge and each of the second patch edges being disposed at substantially a 45° angle relative to each of the first patch edges.

8. The antenna system of claim 5, wherein each patch radiator in the first array of patch radiators is coupled to a plurality of inputs to produce dual-polarization radiation.

9. The antenna system of claim 5, wherein adjacent patch radiators in the first array of patch radiators are coupled to the plurality of inputs to be excited with a substantially 180° phase offset with respect to each other.

10. The antenna system of claim 5, wherein the first array of patch radiators comprises a 2×2 array of patch radiators configured to have less than −7.5 dB return loss from 26.5 GHz to 29.5 GHz and the second array of patch radiators comprises a 2×2 array of patch radiators configured to have less than −10 dB return loss from 37 GHz to 40 GHz.

11. A method of sending radio-frequency signals from a wireless mobile communication device, the method comprising:
radiating first energy in a first millimeter-wave frequency band from an antenna system, comprising multiple layers, of the mobile device and directed outwardly from a side of the mobile device substantially parallel to the multiple layers;
radiating second energy in a second millimeter-wave frequency band from the mobile device and directed outwardly from the side of the mobile device substantially parallel to the multiple layers;
radiating third energy in the first millimeter-wave frequency band from the antenna system of the mobile device and directed outwardly from a front of the mobile device, or from a back of the mobile device, or a combination thereof, substantially perpendicular to the multiple layers; and
radiating fourth energy in the second millimeter-wave frequency band from the antenna system of the mobile device and directed outwardly from the front of the mobile device, or from the back of the mobile device, or a combination thereof, substantially perpendicular to the multiple layers.

12. The method of claim 11, wherein both the first energy and the second energy are radiated from the same radiating elements.

13. The method of claim 12, wherein the third energy is radiated with polarization components that are at substantially 45° angles relative to polarization components of the fourth energy.

14. The method of claim 11, further comprising feeding adjacent patch radiators, in an array of patch radiators, substantially 180° out of phase relative to each other to radiate energy with the third energy.

15. An antenna module comprising:
a first array of radiators configured to radiate a first millimeter-wave signal in a first direction;
a second array of radiators configured to radiate a second millimeter-wave signal in a second direction, the second direction being substantially perpendicular to the first direction, at least a first subset of radiators in the second array of radiators being configured and disposed to radiate the second millimeter wave signal with a first polarization component; and
a third array of radiators configured to radiate a third millimeter-wave signal in the second direction or a third direction, the third direction being substantially opposite the second direction, at least a second subset of radiators in the third array of radiators being configured and disposed to radiate the third millimeter wave signal with a second polarization component that is neither parallel to nor perpendicular to the first polarization component;
wherein the antenna module comprises a plurality of layers containing the first, second, and third arrays of radiators, and wherein the third array of radiators is disposed within a perimeter of the second array of radiators or a projection of the perimeter of the second array of radiators onto a layer of the antenna module containing the third array of radiators.

16. The antenna module of claim 15, further comprising a fourth array of radiators configured to radiate a fourth millimeter-wave signal in a fourth direction, the fourth direction being substantially perpendicular to the first direction and the second direction.

17. The antenna module of claim 15, wherein the first array of radiators is configured to radiate energy in a first millimeter-wave frequency band, the second array of radiators is configured to radiate energy in the first millimeter-wave frequency band, and the third array of radiators is configured to radiate energy in a second millimeter-wave frequency band separate from the first millimeter-wave frequency band.

18. The antenna module of claim 17, wherein the first array of radiators is further configured to radiate energy in the second millimeter-wave frequency band.

19. The antenna module of claim 17, wherein the radiators in the at least a first subset of radiators are configured and disposed, and the radiators in the at least a second subset of radiators are configured and disposed, such that the first polarization component is oriented approximately 45° with respect to the second polarization component.

20. The antenna module of claim 15, wherein the first array of radiators comprises an array of dipole radiators, wherein the second array of radiators comprises a first array of patch radiators, and wherein the third array of radiators comprises a second array of patch radiators.

21. The antenna module of claim 20, wherein the first array of patch radiators comprises a 2×2 array of patch radiators, and wherein the second array of patch radiators comprises a 2×2 array of patch radiators interspersed with the patch radiators in the first array of patch radiators.

22. The antenna module of claim 20, wherein the first array of patch radiators comprises a substantially linear array and wherein the second array of patch radiators comprises a substantially linear array.

23. The antenna module of claim 20, further comprising a first feed network configured to feed adjacent patch radiators in the first array of patch radiators at a substantially 180° phase offset with respect to each other and a second feed network configured to feed adjacent patch radiators in the second array of patch radiators at a substantially 180° phase offset with respect to each other.

24. The antenna module of claim 20, wherein each patch radiator in the first array of patch radiators is coupled to a plurality of first inputs to produce dual-polarization radiation, and wherein each patch radiator in the second array of patch radiators is coupled to a plurality of second inputs to produce dual-polarization radiation.

25. The antenna module of claim 15, wherein at least each of the radiators in the third array of radiators is configured and disposed to radiate the third-millimeter wave signal with the second polarization component and each of the radiators in the second array of radiators is configured and disposed to radiate the second millimeter-wave signal with the first polarization component.

26. A wireless mobile communication device comprising:
a housing;
a screen with a planar top surface;
a processor;
an intermediate-frequency circuit communicatively coupled to the processor;
a front-end circuit communicatively coupled to the intermediate-frequency circuit; and
an antenna system communicatively coupled to the front-end circuit and comprising:
a first antenna sub-system configured to radiate energy in a first millimeter-wave frequency band and to radiate energy in a second millimeter-wave frequency band, the first antenna sub-system configured to have a first boresight directed substantially parallel to the top surface; and
a second antenna sub-system including a first portion configured to radiate energy in the first millimeter-wave frequency band and to have a second boresight directed substantially perpendicular to the top surface, and including a second portion configured to radiate energy in the second millimeter-wave frequency band and to have a third boresight directed substantially perpendicular to the top surface;
wherein the screen, the processor, the intermediate-frequency circuit, the front-end circuit, and the antenna system are retained by the housing.

27. The device of claim 26, wherein the housing is substantially rectangular, the antenna system is a first antenna system and is disposed in a first corner of the housing, and the device further comprises a second antenna system disposed in a diagonally-opposite corner of the housing relative to the first antenna system.

28. The device of claim 27, wherein the first antenna system is further configured to have a fourth boresight directed substantially parallel to the top surface, the first boresight and the fourth boresight being substantially perpendicular to each other, and the second antenna system is configured to have a fifth boresight and a sixth boresight, each directed substantially parallel to the top surface, the fifth boresight being substantially opposite in direction to the first boresight and the sixth boresight being substantially opposite in direction to the fourth boresight.

29. The device of claim 26, wherein the second antenna sub-system is configured to radiate the energy in the first millimeter-wave frequency band with polarization components that are at substantially 45° angles relative to polarization components of the fourth main beam.

30. The device of claim 26, wherein the second antenna sub-system comprises:
an array of patch radiators configured to radiate the energy in the first millimeter-wave frequency band; and
a feed structure coupled to the array of patch radiators to feed adjacent patch radiators substantially 180° out of phase relative to each other.

31. The antenna system of claim 1, wherein the at least one first flat metal portion comprises at least two first flat metal portions and the at least one third flat metal portion comprises a two-dimensional array of at least two third flat metal portions, at least one of the at least two first flat metal portions of the first antenna sub-system is disposed adjacent to a first side of the two-dimensional array of at least two third flat metal portions, and at least one other of the at least two first flat metal portions of the first antenna sub-system is disposed adjacent to a second side, different from the first side, of the two-dimensional array of at least two third flat metal portions.

32. The antenna system of claim 1, wherein the first antenna sub-system and the second antenna sub-system are disposed in a shared substrate of the antenna system.

33. The antenna system of claim 32, wherein the substrate is a multi-layered substrate, the first antenna sub-system is disposed in one or more first layers of the substrate, and the second antenna sub-system is disposed in one or more second layers of the substrate.

34. The antenna system of claim 33, wherein the first layers of the substrate and the second layers of the substrate share at least one layer.

35. The antenna module of claim 15, wherein the first array of radiators, the second array of radiators, and the third array of radiators are disposed in a single substrate.

36. The antenna module of claim 35, wherein the first array of radiators, the second array of radiators, and the third array of radiators are disposed in a first layer, a second layer, and a third layer, respectively, of the single substrate.

37. The device of claim 26, wherein the first antenna sub-system and the second antenna sub-system are disposed in a shared substrate of the antenna system.

38. The device of claim 37, wherein the substrate is a multi-layered substrate, the first antenna sub-system is disposed in one or more first layers of the substrate, and the second antenna sub-system is disposed in one or more second layers of the substrate.
